(19) United States
(12) Patent Application Publication
(10) Pub. No.: US 2009/0010019 A1
(43) Pub. Date: Jan. 8, 2009

(54) Method and apparatus for illuminating tile

(76) Inventor: Richard D. Ashoff, Newport Beach, CA (US)

Correspondence Address: James R. Zarian, 2707 Blue Water Dr., Corona del Mar, CA, 92625, US

(21) Appl. No.: 12/153,215

(22) Filed: May 15, 2008

Related U.S. Application Data
(60) Provisional application No. 60/938,404, filed on May 16, 2007.

(51) Int. Cl. F21V 7/04

(52) U.S. Cl. 362/554; 362/555

(57) ABSTRACT

Illumination of stationary objects to provide adequate illumination in rooms and/or hallways, along walkways, on stairs, around swimming pools, etc. to prevent accidents and illuminate obstacles, leading people to entrances and/or exits and the like. Similarly, illumination of stationary objects may be for decorative purposes.

### CROSS REFERENCE TO RELATED APPLICATIONS

This application claims the benefit of the earlier filing date of U.S. Provisional Application Ser. No. 60/938,404, filed in the U.S. Patent and Trademark Office on filed 16-MAY-2007 the entire contents, which are incorporated herein by reference.

### FIELD OF THE INVENTION

This invention pertains to illumination and, more particularly, to the illumination of stationary objects.

It is frequently desirable, if not mandatory, to provide adequate illumination in rooms and/or hallways, along walkways, on stairs, around swimming pools, etc. to prevent accidents, Illuminate obstacles, lead people to entrances and/or exits and the like. Similarly, it is frequently desirable to utilize illumination for decorative purposes.

### SUMMARY OF THE INVENTION

The invention herein provides a method and system for accomplishing this, while permitting the light source to be located in a place that is easily accessible to authorized personnel for replacement if needed.

Briefly, one or more optical fiber cables communicate with one or more light sources at a proximal end and one or more optically transmissive (e.g., transparent or frosted) tiles or optical panels at a distal end to decoratively illuminate an area and/or to mark the location of obstacles, pathways or locations so they can easily be identified in a dark or dim environment. The tiles can be any of numerous colors and/or color combinations, as can the light source(s). The resulting system can, for example, be used to lead building occupants to safety, help occupants avoid injury when entering an otherwise dark room, and guide pedestrians around hazards such as pools and other architectural features.

Another aspect of the invention provides an illumination method and system that produces a highly decorative effect by backlighting tiles. The tiles may form an illuminated matrix that cooperatively form a work of art, or may be laid out along walls, stairs, furniture and the like to provide illumination that can be static, dynamic or selectively both. In a dynamic mode, the lighting can be responsive to sounds such as music to vary in intensity and/or color to turn the lit surroundings into a visually dynamic environment.

In the preferred embodiment, one or more optical fiber cables communicate between (1) one or more lights sources at a relatively proximal end region and (2) one or more optical panels at a relatively distal region, and are optically coupled to one or more optically transmissive (e.g., transparent or frosted) tiles via the optical panels. Fiber optic cables and fiber optic panels usable with this invention are, for example, available from Lumitex, Inc. of Strongville, Ohio. The optical fibers within the cable are optically coupled to a light source such as a light bulb, an LED, etc.) at their proximal ends and to the optical panel at respective distal regions along their lengths. The optical panel is preferably uniformly lit by the light exiting from the fibers, and is preferably affixed to the optically transmissive tile via an optically transmissive adhesive, glue or epoxy. The panel can be the same size as the tile; alternatively, it can be smaller than the tile depending on the visual effect that is desired or larger than the tile if one panel is to transmit light to more than one tile.

The use of the optical panel minimizes or eliminates the occurrence of optical “hot spots” and “dead zones” because it is generally uniformly illuminated by the optical fibers' output. This is particularly true where the light exiting from the optical fiber exits from the side of the fiber rather than its tip, yielding a relatively spatially-dispersed field of illumination. Alternatively, the optical fibers can be coupled at their distal end regions directly to the optically transmissive tiles, although this appears at the time to be more labor-intensive and therefore less desirable. In practice, it has been found that a 40 watt bulb can function as a light source, and that the tiles can be 20 feet to 40 feet away or more from the light source. The light source can also comprise LEDs and LED arrays. In practice, one LED per light panel can be used as well. Regardless of light source type, the light source can accordingly be in a location where it is easily accessible to those who need to service it and/or only to those who are authorized to do so.

In accordance with the invention, the tiles can be run as a wainscot around a room so that room can be lit at a low but sufficient level all of the time in an energy-efficient manner to permit people to always walk into a lit room. Similarly, the tiles can be laid around the base of the floor, around pools, along walkways, and on stairs. As a result, obstacles and potentially dangerous conditions are always visible. The tiles can also be laid out to illuminate the area in a way that leads pedestrians to and through exit in dark in event of power failure (battery back-up) or emergency. At the same time, minimal heat (if any) is generated at the tile, and there is no electric power that can be contacted by the pedestrian even if the integrity of the tile or structure surrounding the tile is compromised. From both a decorative and functional standpoint, a variety of colors is possible. First, the light source may be any of a number of available color light sources. Further variations can be obtained by using color tiles or multi-color tiles, including stained glass tiles. The pattern of illumination can be varied by shaping the fiber optic panel behind the tile. A backing layer may be used to sandwich the optical panel between the backing and the tile for additional structural support. The tiles may be laid in place directly, or using a bracket. The backlit tile resulting from this invention provides a decorative element and/or a safety feature that is limited only by the designer's imagination. These and other details will become apparent from the following description of the preferred embodiment, of which the drawing forms a part.

### DESCRIPTION OF THE DRAWING

FIG. 1 (comprising FIG. 1a-c) is a front elevation view of an illumination panel assembly constructed in accordance with the invention, with FIG. 1c showing a more refined depiction of the tray therein;

FIG. 2 is a right side elevation view of the illumination panel assembly of FIG. 1;

FIG. 3 is a rear elevation view of the illumination panel assembly of FIG. 2;

FIG. 4 is a right side elevation view of the rear section of the illumination panel assembly;

FIG. 5 is a rear elevation view of center section 20 of FIG. 2;

FIG. 6 is a rear elevation view of center section 20 of FIG. 2 with a backlighting assembly and light source in accordance with the invention;

FIG. 7 is a schematic illustration of a backlighting assembly in accordance with the invention;

FIG. 8 is a front elevation view of the front section 18 of the illumination assembly shown in FIG. 2;

FIG. 9 is side elevation, bottom plan, and end elevation views of another embodiment of an illumination system constructed in accordance with the invention.

### DESCRIPTION OF THE PREFERRED EMBODIMENT

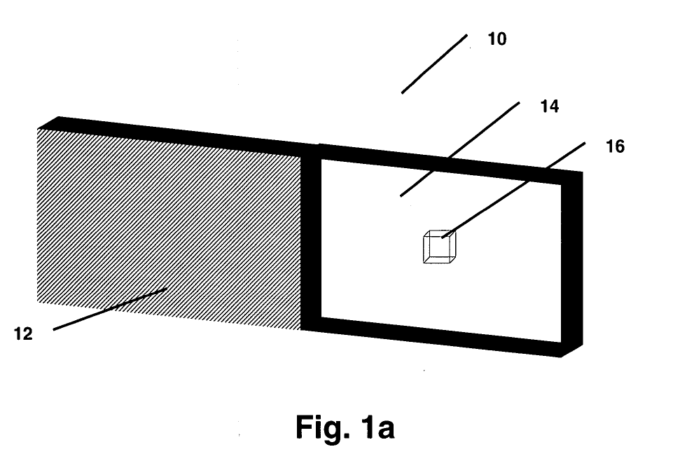

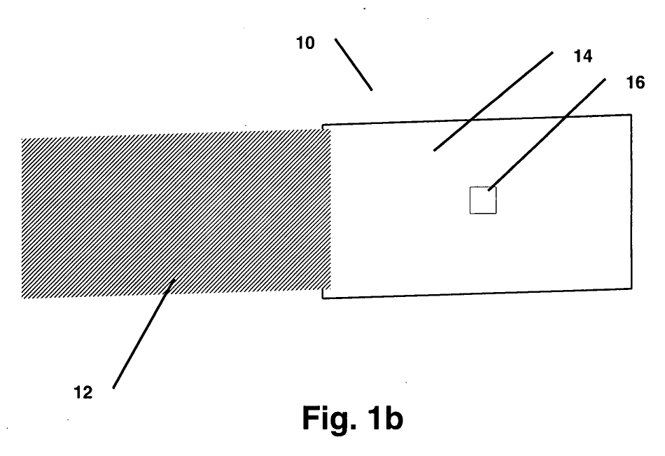

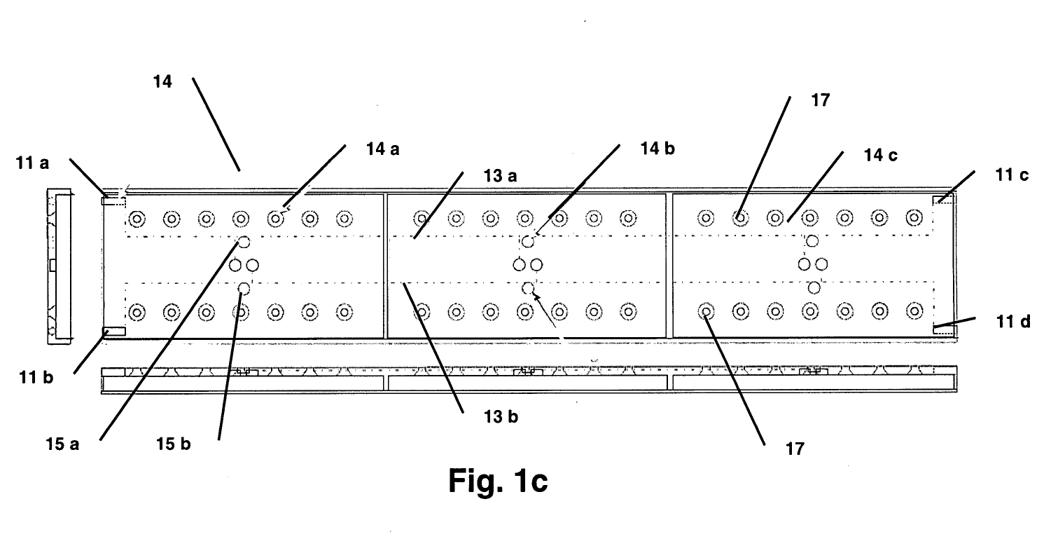

FIG. 1a is a front elevation view of an illumination panel assembly 10 constructed in accordance with the invention and useful for applications wherein lighting is to be incorporated into a wall in accordance with the invention. The illumination panel assembly 10 is adapted to be mounted, for example, within drywall or other material of an interior wall, and comprises an illumination assembly 12 mounted within a tray 14, preferably with the front surface of the illumination assembly 12 being flush with the surface of the wall.

In FIG. 1, the illumination assembly 12 has been removed from a portion of the tray 14 to illustrate the preferred structure of the tray. The tray 14 is preferably formed from a fire-rated, injection molded plastic as thick as the intended drywall so that it can be retrofit into any building. The tray 14 is preferably divided into a plurality of tray segments 14a, 14b, 14c that each accommodate a respective illumination assembly 12.

In practice, it is desirable to provide the tray in various lengths to accommodate various run-lengths along the wall: e.g., 12 inch, 18 inch, 24 inch, and 36 inch lengths that respectively accommodate 2, 3, 4 and 6 illumination panel assemblies 10 in respective tray segments. Each illumination assembly 12 is preferably grouted or otherwise secured within a respective tray segment. Grouting is preferred in that it permits the illumination panel 12 to be removed from the tray for easy replacement.

Turning to FIG. 1c, each tray 14 includes a pair of side-facing dowel holes 11a, 11b at its left end, and a pair of side-facing dowel holes 11c, 11d at its right end. A male or female electrical connector is located in the dowel holes; as will be self-evident, the specific type of connector is not important so long as they provide a means for coupling electric power to the tray segments. An electrical conductor 13a extends along the back surface of the tray 14 to electrically couple dowel hole 11a and dowel hole 11c. Similarly, a second electrical connector 13b extends along the back surface of the tray 14 to electrically couple dowel hole 11b and dowel hole 11d. The rear face of each of the tray segments 14a-c includes a pair or of connector accommodating holes 15a, 15b that accommodate a respective electrical connector (or conductor) through which power is supplied to the illumination assembly 12 in the tray segment. A pair of terminals 15c, 15d is accordingly located on the front face of the tray segment and are electrically coupled to the connectors/conductors associated with the holes 15a, 15b for connection to the illumination assembly 12 in the tray segment. Power can be applied to the illumination panel assemblies 12 in each tray via the electrical connectors in the dowel holes 11a, 11b, or through the connectors/conductors associated with the holes 15a, 15b of a tray segment. In either case, power is applied to all segments in the tray via conductors 13a, 13b, and the trays themselves can be are electrically “daisy chained” together by interconnecting the connector in dowel holes 11c, 11d with the electrical connectors in dowel holes 11a, 11b of the neighboring tray. This flexibility enables an installer to power the illumination assemblies from the most convenient location, whether at one end of the tray deployment or from internal wiring within the wall at one or more intermediate locations along the line of trays. Moreover, the described configuration enables an installer to place trays contiguous to each other, or leave gaps between some or all of them to obtain different visual effects when the illumination panel assemblies 10 are activated while easily powering all of the trays. Trays can be electrically coupled together or arranged as separately powered groups (of one or more trays), with each group being coupled to a different power line or circuit beaker to provide at least a degree of parallel electrical connection that prevents all illumination assemblies 12 from becoming inactive if a fault arises with respect to one of them as in a serial connection arrangement. A plurality of screw (or nail) holes 17 are disposed generally linearly along the top and bottom of the tray segments for accommodating screws (or nails) that secure the tray to studs in the wall. The holes 17 are approximately ¾-inch (1.9 cm) apart to accommodate variations in the relative position of the studs and tray segment. Those skilled in the art will recognize that one or two pairs of screws will normally be sufficient to secure the tray within the wall.

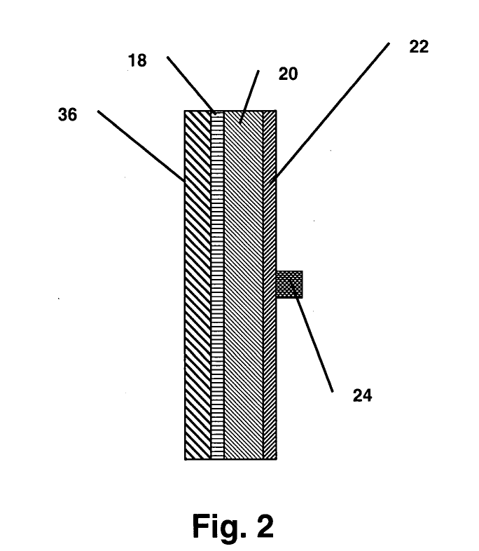

FIG. 2 is a right side elevation view of the illumination panel assembly 10 depicted in FIG. 1A. The illumination panel assembly comprises a front section 18, a central section 20 a rear section 22 and a light-transmitting tile 36 mounted to the front section 18. An electrical connector 24 protrudes from the rear face of the rear section 22, and is sized to pass through the hole 16 in the tray 14 when the illumination assembly 12 is mounted within a tray segment. Alternatively, the connector 24 can be replaced by male and/or female connectors located within the holes 15a, 15b of the tray illustrated in FIG. 1c; this latter configuration avoids the possibility of the connector 24 being damaged during installation or shipment.

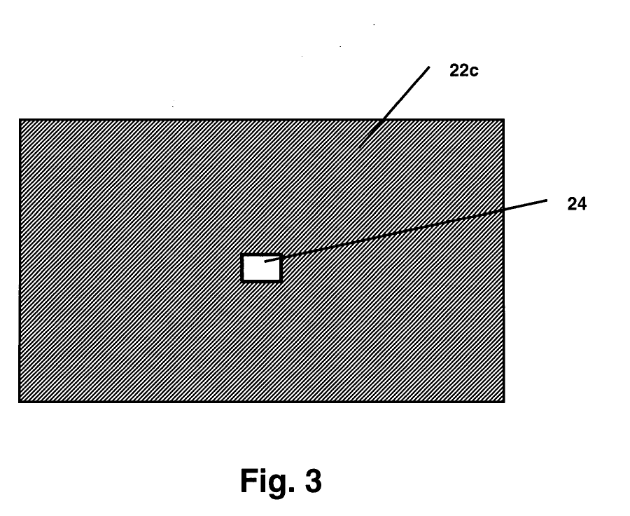

FIG. 3 is a rear elevation view of the illumination panel assembly of FIG. 2, illustrating the connector 24 extending through the rear face 22c of the rear section 22.

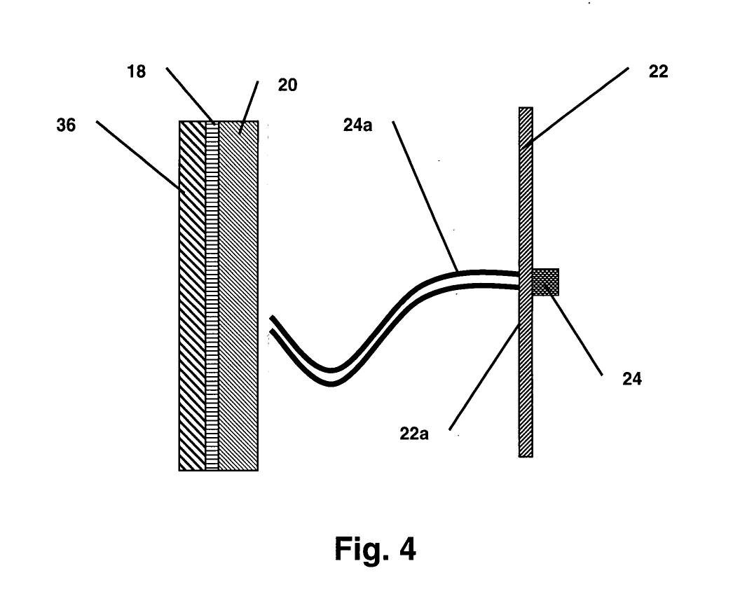

FIG. 4 is a right side elevation view of the rear section 22 of FIG. 3, illustrating a pair of electric conductors 24a extending from the front face 22a of the rear section 22. The conductors 24a are electrically coupled to respective terminals in the connector 24. Alternatively, the conductors 24a may be replaced by the terminals 15c, 15d (FIG. 1c) or may extend from those regions instead of from a connector such as connector 1 24. The electric conductors 24a (or the terminals 15a, 15b) electrically couple power to a light source positioned within the center section 20, such as an LED (FIG. 2).

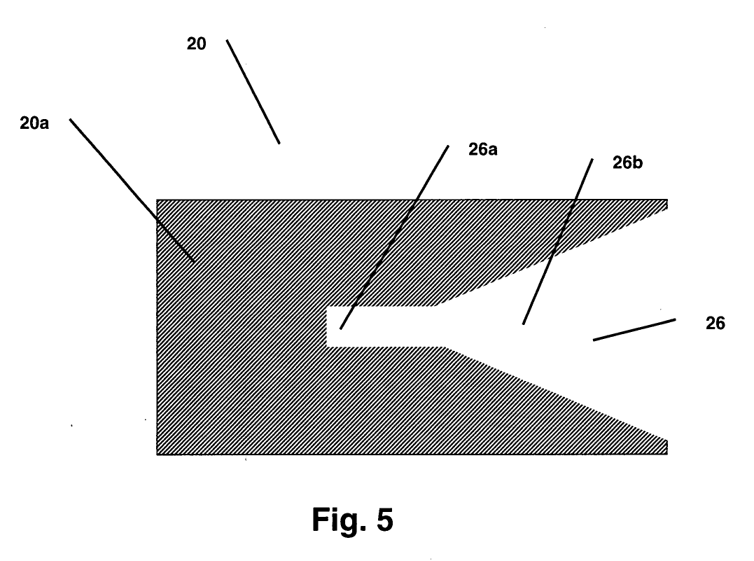

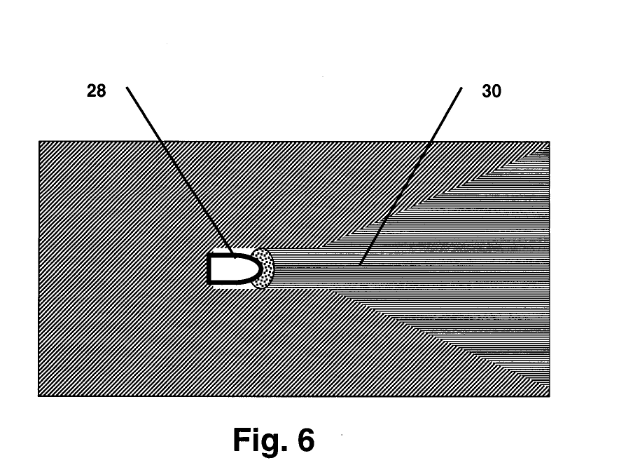

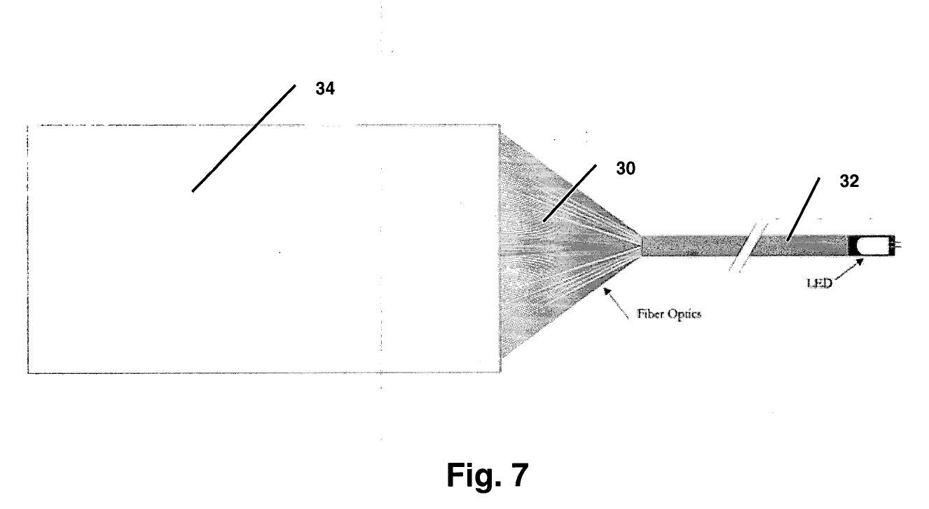

FIG. 5 is a rear elevation view of center section 20 (FIG. 2). Center section 20 comprises a rear face 20a and defines a void 26 that, as illustrated in FIG. 6, accommodates an LED 28 that is optically coupled to a plurality of optical fibers 30. The void 26 is preferably provided with a slot portion 26a sized to accommodate the LED and a diverging portion 26b that extends outwards towards the side of the center section to accommodate the splayed shape of the optical fibers as they extend from the LED towards their respective distal ends. The center portion 20 is sufficiently thick to permit the center section 20 to abut the front section 18 and rear section 22 (FIG. 2) while accommodating the cross-sectional dimension of the LED 28 (FIG. 6). The optical fibers 30 are part of an optical assembly that comprises a plurality of optical fibers adapted to be coupled at their proximal ends to a source of light such as an LED, and affixed along a substantial portion of their lengths to a transparent, semi-transparent or translucent panel. The optical fibers are processed so that transmitted light is emitted from their sides through its cladding along the substantially entire surface of the panel. FIG. 7 is a schematic illustration of one such optical assembly available from Lumitex, Inc. under the trademark Poly-Optical® UniGlo® and comprises a ferrule 32 sized and shaped to optically couple a light source to the proximal end of a plurality of side-emitting optical fibers 30. The optical fibers 30 are affixed along a substantial portion of their lengths to an optical panel 34 so that the light is side-emitted into the panel to substantially evenly illuminate the panel. The optical panel is preferably a fiber panel that uniformly emits a diffuse light over its relatively large surface area. The optical fibers extend from the panel in a cable form for connection to a remote light source such as one or more LEDs.

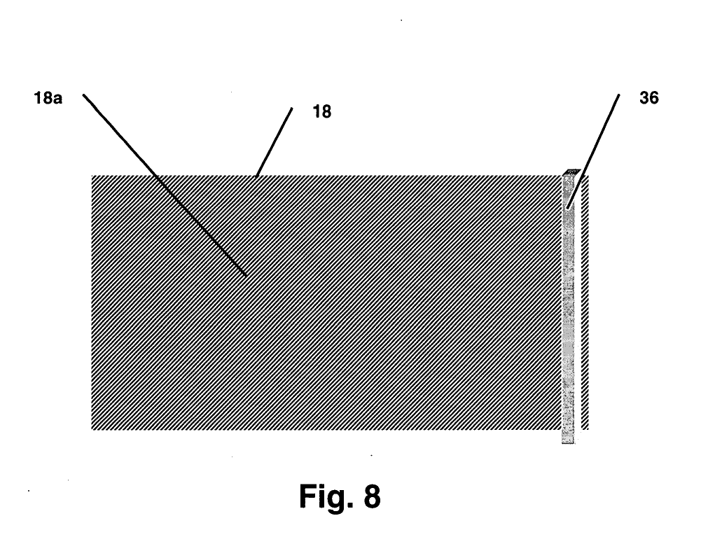

FIG. 8 is a front elevation view of the front section 18 of the illumination assembly (FIG. 2). The front section 18 has a front face 18a sized and shaped to underlie and support the optical panel 34 (FIG. 7). The front section 18 has a slot 36 through which the optical fibers 30 and/or optical panel 34 can pass from the rear of the front section 18 to its front, as best illustrated in FIG. 6. In accordance with the invention, a translucent or transparent tile of glass, stained glass, plastic, onyx, quartz, porcelain, ceramic, stone or other suitable light-transmitting material (hereinafter referred to collectively and individually as “tile”) is affixed to the front face 18a of front section 18 to provide the desired decorative or visual effect when lit from beneath by the illumination assembly. The tile 36 can be as decorative as desired, with any number of patterns being possible and being limited only by the decorator's or installer's imagination.

Alternatively, the tile can be functional, such as being color-coded for significance as described below. The tile 36 is preferably affixed to the front surface of the front section with a clear, double-sided adhesive tape that permits easy removal if desired. Any other opaque, transparent or translucent means can be used that does not interfere with the desired degree of light transmission from the front section to the tile. For example, an opaque glue or epoxy can be used in selected locations, or a clear/translucent glue or epoxy can be used. The tile can be mechanically captured against the front section 18 by such means as a mechanically fastened frame, or by such fastening means as screws, clamps, and the like. The foregoing embodiment of the invention has several practical advantages. First, it can be used during remodeling of the existing construction or during new construction. The trays are adapted to interlock with one another for maximum flexibility, and can be trimmed to suit individual requirements. The illumination assembly 12 can be provided as a pre-wired, fiber optical “plug-in” unit that simply plugs into the trays. It will be recognized that select illumination panel assembly may be formed from a single integrated structure instead of the structure illustrated herein without departing from the scope of the invention. In accordance with the preferred embodiment, however, the front, central and rear sections are bonded together with a glue or epoxy so that the assembly can subsequently be disassembled to replace internal components if desired.

Illumination panel assemblies of the type described above, as well as those having entirely different structures, can be used for numerous purposes. For example, the illumination panel assemblies can be incorporated into the interior walls of a building to provide a visual alarm and/or guide system. The system employing them can be configured to utilize colors indicative of specific alarm conditions, if desired, and can be cyclically illuminated in a phased manner under microprocessor control to guide people towards exits or other destinations. In hospitals, for example, the system can be responsive to the activation of an alarm used in a “Code Blue” or other emergency to guide medical personnel to the location at which the event is occurring, eliminating the need to remember room numbers or await verbal instructions that may be mis-communicated or misunderstood in the stress of the moment. The alarm can be activated manually or automatically by life-monitoring medical equipment. The system can, for example, be configured to flash the color blue in a Code Blue emergency, and other colors for other emergencies. Illumination panel assemblies of the type described above, as well as those having entirely different structures, can be used can provide constant lighting as a safety measure, as a visual guide at night, or as a visual guide when normal lighting fails or is insufficient. They require only milliamps of current at very low voltages and have exceedingly high life expectancy owing to the use of solid state light sources and optical fiber waveguides.

Similarly, illumination panel assemblies of the type described above, as well as those having entirely different structures, can be used to guide people within a building or shopping mall to the nearest exit in the event of a need to evacuate. Shopping malls, for example, are known to be designed to mask exits in order to induce shoppers to detach from the outside world and spend more time shopping. In an emergency such as a fire, hidden exits can be a source of liability and loss of life. Illumination panel assemblies, especially when operated in a phased manner to direct occupants in a particular direction, can guide shoppers to the nearest exits while remaining unobtrusive and even unseen when not in use.

Moreover, illumination systems employing illumination panel assemblies of the type described above, as well as those having entirely different structures, can be sufficiently flexible to change the direction in which people are being guided as conditions change. When the nearest safe exit is no longer safe, as in the case of a fire, a shooter or other changeable and dangerous condition, the phasing can be changed under manual or microprocessor control to guide occupants in a different direction.

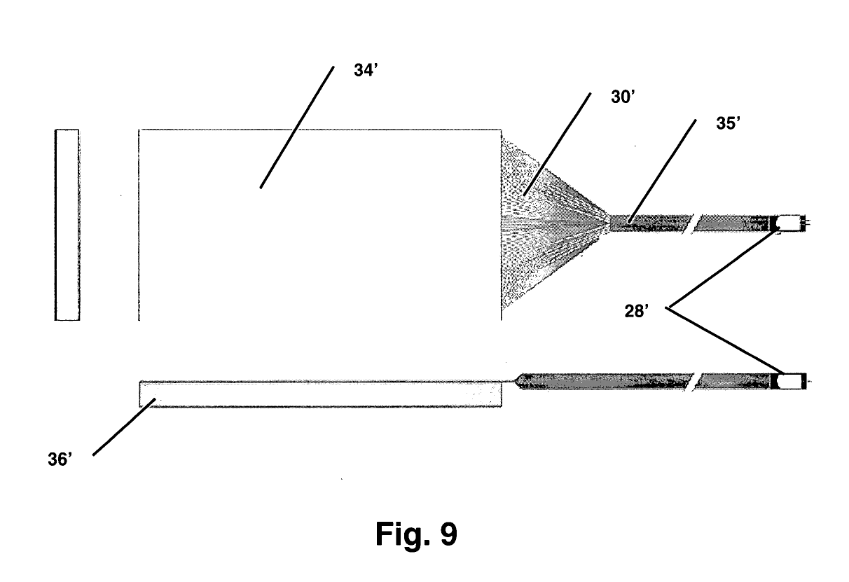

Illumination panels can also be used for decorative purposes. Under manual or microprocessor control, both static and dynamic lighting can be implemented whereby entire rooms, stairs, furniture, bars, and swimming pools can become visually dynamic as systems employing illumination panel assemblies of the type described above, as well as those having entirely different structures are utilized to give lighting effects to these structures. In the lighting of swimming pools, and for other applications, it may not be desirable to place electrical conductors nears the lighting. Under such circumstances, optical cables can be utilized to couple optical panels 34 to lighting sources as much as 40 feet away, and to place tiles on the panels where the lighting effect is desired. Accordingly, there are numerous applications where a single light source is not needed for each tile, and where it is desired to light backsplashes, chair rails, existing baseboards, stairs, and pieces of furniture. In such cases, the afore described tray can be eliminated, and a lighting assembly as thin as tape can be affixed to such surfaces to add mood and light without transferring heat or electricity to the tile. As shown in FIG. 9, an illumination system of this type comprises an optical panel 34′ to which a tile 36′ has been affixed by such means as an optically transmissive adhesive or glue. The optical panel 34′ is lit by a plurality of optical fiber waveguides 30′ splayed along the width and length of the panel 34′. The optical fiber waveguides 30′ are formed into a cable 35′ which optically couples the panel 34′ to a light source 28′ such as an LED. By this configuration, the light panel and lit tile can be as much as 40 feet away from the light source, permitting the light source to be placed in a location that is easily accessible or accessible only to authorized personnel, depending on the installer's goal. Accordingly, the light source can be located a sufficient distance from the object to be lit to avoid interference with the resulting visual effect or aesthetics and/or the occupying of desirable space by light sources, power supplies and circuit boards. One benefit of this configuration is that the tile installation does not have to be disturbed to change out the light source because the light source is up to 40′ or more away. Light sources used for this system have ranged from LEDs, halogen bulbs, and lighting sources that provides an array of RGB or CMY colors such as the Martin FiberSource CMY150 shown and described, for example, at http://www.martin.com/product/product.asp?product=fibersourcecmy150. Using light sources more powerful than LEDs permits the light source to be located further away from the illuminated tiles than the current LED limitation of approximately 40 feet.

1. An illumination embodiment comprising:
a backlight system including;
a light-guiding element having an upper surface and a lower surface formed of fiber optics;
wherein fiber optics forming the light-guide element extending away from the light-guide element and coupling into;
a light source disposed to the light-entrance surface of the fiber optics;
wherein the backlighting system disposed at a position underneath an object to be evenly irradiated;
forming an illuminated embodiment.

2. The illumination embodiment according to claim 1,
wherein the light source is a light emitting diode.

3. The backlight system according to claim 1,
wherein the object is a transparent and/or translucent.
